(19) United States
(12) Patent Application Publication
(10) Pub. No.: US 2016/0239188 A1
(43) Pub. Date: Aug. 18, 2016

(54) SYSTEM AND METHOD FOR PHOTO SUBJECT DISPLAY OPTIMIZATION

(71) Applicant: SMUGMUG, INC., Mountain View, CA (US)

(72) Inventor: Brian STRONG, San Jose, CA (US)

(21) Appl. No.: 15/042,711

(22) Filed: Feb. 12, 2016

Related U.S. Application Data
(60) Provisional application No. 62/116,259, filed on Feb. 13, 2015.

(51) Int. Cl. G06F 3/0484

(52) U.S. Cl. CPC G06F 3/04845; G06F 3/04842

(57) ABSTRACT

A software application platform which provides a user with the ability to customize, via the uploading of digital photographs, the displayable area of a digital photo in an image gallery such that the photo subject for each digital photo is viewable within the image gallery on a graphical user interface is disclosed. Photos, each having a first aspect ratio, uploaded to an image gallery may be processed by the application such that the photo subject and the photo subject area of each digital photo is identified and positioned within an individual display window, each display window having a second aspect ratio, such that the display window displays the photo subject area in an image gallery on a graphical user interface. The application allows for customization to the look and feel of an image gallery while maintaining a display of the photo subject area.

### CROSS-REFERENCE TO RELATED APPLICATIONS

This application claims benefit of U.S. Provisional Patent Application No. 62/116,259, filed Feb. 13, 2015, the entirety of which is herein incorporated by reference.

### BACKGROUND

1. Field

Embodiments of the present disclosure generally relate to the field of computer software. More specifically, embodiments provided herein relate to a system and method for generating and applying a photo subject display to an image gallery on a graphical user interface.

2. Description of the Related Art

The production and availability of information and media has gained prevalence in today's society. The ability to instantly access and share information, experiences, news, photos, and videos over the internet has revolutionized the way people connect, learn, consume information, and participate in today's society.

In recent years, the popularity of personal web pages that are hosted by web service providers has increased. Examples of such personal web pages include profile pages on social network websites, personal blog web pages, personal online photo galleries, and the like. There exists a strong connection between a user and their personal web pages that has lead web page service providers to enable their customers to customize the look and feel of their personal web pages. For example, some web service providers allow web page users to upload photos that are displayed on their personal web pages, and/or allow web page users to edit the font size and typeface displayed on their personal web pages. Some web service providers further enable web page users to create a sharable photo gallery in which only select portions of the available photos are displayed on the gallery web page and seen on a graphical user interface, until the photo is selected by a user redirecting the user to a new web page.

One popular approach of modifying the viewable portion of a photo in a photo gallery on a user interface element involves the user manually selecting one or more areas of the photo, such as by cropping the photo such that the desired area of the photo is remains viewable. However, a large number of user interface elements are typically included in even the simplest of personal web pages; therefore, the manual selection process quickly becomes cumbersome. Moreover, a majority of individuals do not understand the complexities involved with photo editing, and what is aesthetically pleasing, which results in web page users conducting a trial-and-error process that further contributes to the burdensome task of customizing a personal web page. Additionally, a photo subject may be left out of view in the viewable portion of a photo in a photo gallery which may inhibit the viewing experience of a photo gallery web page.

As the foregoing illustrates, there is a need for an improved technique for applying a photo subject display to an image gallery on a graphical user interface, such as that displayed from a personal web page. More specifically, what is needed in the art is a photo subject display application.

### SUMMARY

The present disclosure generally relates to a software application platform which provides a user with the ability to customize, via the uploading of digital photographs in their original aspect ratio, the displayable area of a digital photo in an image gallery such that the photo subject for each digital photo is viewable within the image gallery on a graphical user interface. Photos, each having a first aspect ratio, uploaded to an image gallery may be displayed by the application such that the photo subject and the photo subject area of each digital photo is identified and positioned within an individual display window, each display window having a second aspect ratio, such that the display window displays the photo subject area in an image gallery on a graphical user interface. A user may select the display window to further view the photo in the second aspect ratio. The display windows allow for customization to the look and feel of an image gallery (e.g., maintaining uniformity or promoting uniqueness), such as the size or shape of photos displayed, while maintaining a display of the photo subject area.

In one embodiment, a method for analyzing and applying a photo subject display to an image is disclosed. The method includes receiving a selection of a gallery display scheme wherein the gallery display scheme comprises one or more display windows. Each display window may comprise one or more first aspect ratios. The method further includes receiving one or more digital photos having one or more second aspect ratios. Furthermore, the method includes identifying a photo subject for each of the one or more digital photos, and identifying a photo subject area for each of the one or more digital photos defined by the photo subject of each of the one or more digital photos. The method also includes positioning the photo subject area of each of the one or more digital photos within the one or more display windows such that each display window displays the photo subject area of one of the one or more digital photos, and wherein the photo subject area is displayed within the display window regardless of the one or more first aspect ratios. The method also includes displaying the display windows in a gallery on a graphical user interface.

In another embodiment, a computer system for analyzing and applying a photo subject display to an image is disclosed. The computer system for analyzing and applying a photo subject display to an image may include a processor and a memory storing instructions that, when executed by the processor, cause the computer system receive a selection of a gallery display scheme wherein the gallery display scheme comprises one or more display windows. Each display window may comprise one or more first aspect ratios. The computer system may further receive one or more digital photos having one or more second aspect ratios. Furthermore, the computer system may identify a photo subject for each of the one or more digital photos, and identify a photo subject area for each of the one or more digital photos defined by the photo subject of each of the one or more digital photos. The computer system may also position the photo subject area of each of the one or more digital photos within the one or more display windows such that each display window displays the photo subject area of one of the one or more digital photos, and wherein the photo subject area is displayed within the display window regardless of the one or more first aspect ratios. The computer system also may display the display windows in a gallery on a graphical user interface.

In yet another embodiment, a non-transitory computer-readable medium, storing instructions that, when executed by a processor, cause a computer system to analyze and apply a photo subject display to an image is provided. The processor may perform the steps of receiving a selection of a gallery display scheme wherein the gallery display scheme comprises one or more display windows. Each display window may comprise one or more first aspect ratios. The processor may further perform the step of receiving one or more digital photos having one or more second aspect ratios. The processor may also perform the steps of identifying a photo subject for each of the one or more digital photos, and identifying a photo subject area for each of the one or more digital photos defined by the photo subject of each of the one or more digital photos. Furthermore, the processor may perform the step of positioning the photo subject area of each of the one or more digital photos within the one or more display windows such that each display window displays the photo subject area of one of the one or more digital photos, and wherein the photo subject area is displayed within the display window regardless of the one or more first aspect ratios. The processor may also perform the step of displaying the display windows in a gallery on a graphical user interface.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 illustrates a computer system configured for providing a website having a photo subject display application according to one embodiment described herein.

FIG. 2 illustrates a more detailed view of a server of FIG. 1 according to one embodiment described herein.

FIG. 3 illustrates a user computing system used to access a website and utilize the photo subject display application according to one embodiment described herein.

FIG. 4A illustrates a first conceptual diagram of applying a photo subject display to a digital photo, according to embodiments described herein.

FIG. 4B illustrates a second conceptual diagram of applying a photo subject display to a digital photo, according to embodiments described herein.

FIG. 4C illustrates a third conceptual diagram of applying a photo subject display to a digital photo, according to embodiments described herein.

FIG. 5 illustrates a first conceptual diagram of applying a photo subject display to a user interface, according to embodiments described herein.

FIG. 6A illustrates a fourth conceptual diagram of applying a photo subject display to digital photo, according to embodiments described herein.

FIG. 6B illustrates a second conceptual diagram of applying a photo subject display to a user interface, according to embodiments described herein.

FIG. 6C illustrates another embodiment of the conceptual diagram of FIG. 6B, wherein a photo subject display correction is applied to a digital photo on a user interface, according to embodiments described herein.

FIG. 7 schematically illustrates operations of a method for applying a photo subject display operation according to one embodiment described herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments described herein generally relate to the display of photo subjects and an application which receives a selection of a gallery display scheme comprising one or more display windows, analyzes, identifies, determines, assigns, selects, positions, generates, applies, and displays a photo subject area containing a photo subject within each of the display windows within an image gallery on a graphical user interface. For example, a webpage may store various digital photographs in an image gallery such that the digital photographs can be accessed by a computing device upon request by a user or an application. The application may automatically analyze, identify, and determine a photo subject and a photo subject area of each image displayed within the image gallery on the graphical user interface connected to the computing device in order to apply and display a display window comprising the photo subject area containing the photo subject to the image gallery as displayed on the graphical user interface.

The term “user” as used herein includes, for example, a person or entity that owns a computing device or wireless device; a person or entity that operates or utilizes a computing device or a wireless device; or a person or entity that is otherwise associated with a computing device or a wireless device. It is contemplated that the term “user” is not intended to be limiting and may include various examples beyond those described.

The term “image” as used herein includes, for example, messages, photos, videos, blogs, advertisements, notifications, and various other types of media which may be visually consumed by a user. It is contemplated that the term “image” is not intended to be limiting and may include various examples beyond those described.

The term “display window” as used herein includes, for example, a custom graphical appearance package achieved by the use of a graphical user interface that can be applied to computer software, operating systems, websites, and the like in order to suit the purpose, topic, or tastes of different users without affecting the functionality of the interface. The term “display window” may include, but is not limited to, the area containing the primary subject of an image or text as displayed on a webpage and as viewed on a graphical user interface. The display window may be viewed as representing a portion of a larger image, or the entire image, such that the main subject or idea of the full image may be grasped and is intended to make it easier, faster, and/or visually cohesive to look at or manage a group of images (e.g., those in an image gallery) on a webpage in order to enhance the information displayed on the webpage. It is contemplated that the term “display window” is not intended to be limiting and may include various examples beyond those described.

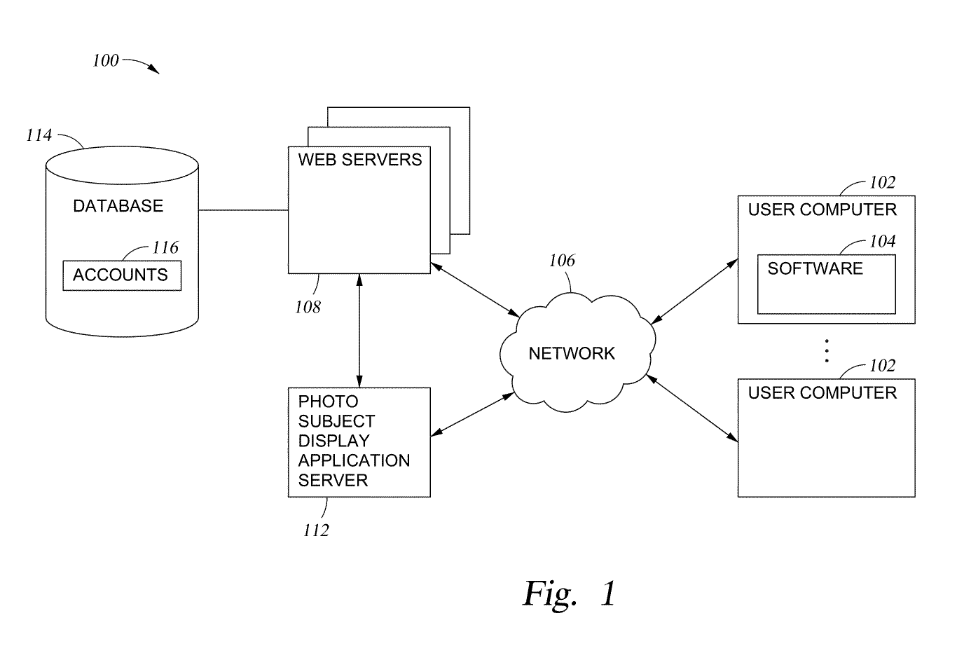

FIG. 1 illustrates a computing system 100 configured for providing a photo subject display application in which embodiments of the disclosure may be practiced. As shown, the computing system 100 may include a plurality of web servers 108, a photo subject display application server 112, and a plurality of user computers (i.e., mobile/wireless devices) 102 (only two of which are shown for clarity), each connected to a communications network 106 (for example, the Internet). The web servers 108 may communicate with the database 114 via a local connection (for example, a Storage Area Network (SAN) or Network Attached Storage (NAS)) or over the Internet (for example, a cloud based storage service). The web servers 108 are configured to either directly access data included in the database 114 or to interface with a database manager that is configured to manage data included within the database 114. An account 116 is a data object that stores data associated with a user, such as the user's email address, password, contact information, billing information, photo subject displays for his or her personal web page(s), and the like.

Each user computer 102 may include conventional components of a computing device, for example, a processor, system memory, a hard disk drive, a battery, input devices such as a mouse and a keyboard, and/or output devices such as a monitor or graphical user interface, and/or a combination input/output device such as a touchscreen which not only receives input but also displays output. Each web server 108 and the photo subject display application server 112 may include a processor and a system memory (not shown), and may be configured to manage content stored in database 114 using, for example, relational database software and/or a file system. The web servers 108 may be programmed to communicate with one another, user computers 102, and the photo subject display application server using a network protocol such as, for example, the TCP/IP protocol. The photo subject display application server 112 may communicate directly with the user computers 102 through the communications network 106. The user computers 102 are programmed to execute software 104, such as web browser programs and other software applications, and access web pages and/or applications managed by web servers 108 by specifying a uniform resource locator (URL) that directs to web servers 108.

In the embodiments described below, users are respectively operating the user computers 102 that are connected to the web servers 108 over the communications network 106. Web pages are displayed to a user via the user computers 102. The web pages are transmitted from the web servers 108 to the user's computer 102 and processed by the web browser program stored in that user's computer 102 for display through a display device and/or a graphical user interface in communication with the user's computer 102.

In one example, images displayed on the user's computer 102 may be a digital photograph accessed via an online photo gallery. The user's computer 102 may access the online photo gallery via the communications network 106 which, in turn, retrieves the online photo gallery from the web servers 108 connected to the database 114 and causes the images to be displayed through a graphical user interface of the user's computer 102. The online photo gallery may be managed with a username and password combination, or other similar restricted access/verification required access methods, which allow the user to “log in” and access the images.

It is noted that the user computer 102 may be a personal computer, laptop mobile computing device, smart phone, video game console, home digital media player, network-connected television, set top box, and/or other computing devices having components suitable for communicating with the communications network 106. The user computer 102 may also execute other software applications configured to receive image content and photo subject information from the photo subject display application, such as, but not limited to, image display software, media players, computer and video games, and/or widget platforms, among others.

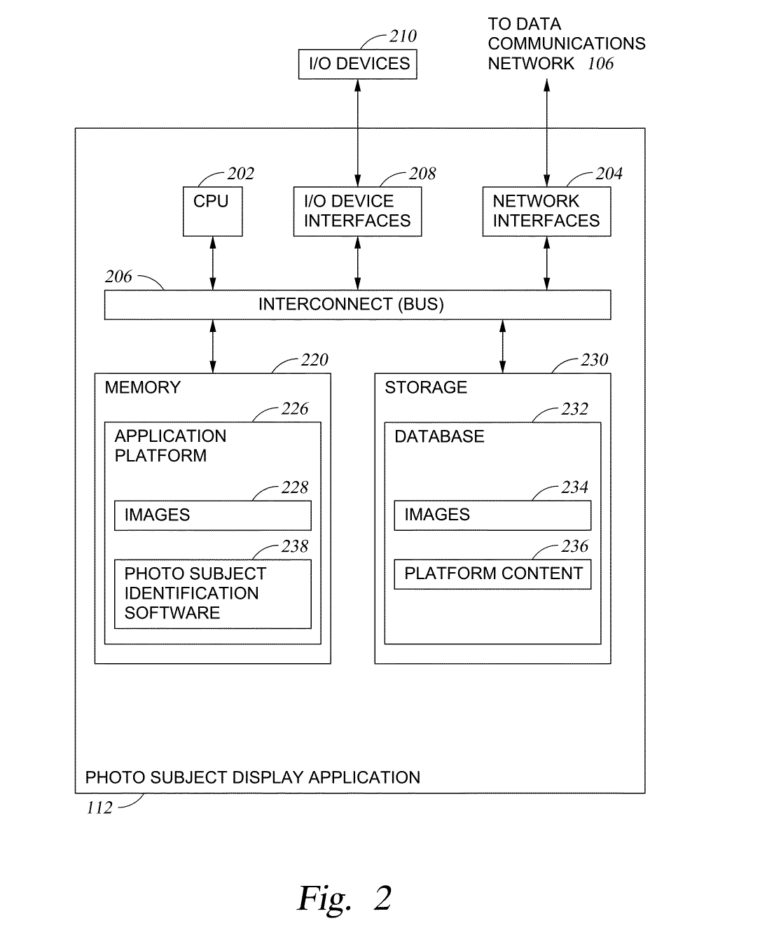

FIG. 2 illustrates a more detailed view of the photo subject display application server 112 of FIG. 1. The photo subject display application server 112 includes, without limitation, a central processing unit (CPU) 202, a network interface 204, memory 220, and storage 230 communicating via an interconnect 206. The photo subject display application server 112 may also include I/O device interfaces 208 connecting I/O devices 210 (for example, keyboard, video, mouse, audio, touchscreen, etc.). The photo subject display application 112 may further include the network interface 204 configured to transmit data via the communications network 106.

The CPU 202 retrieves and executes programming instructions stored in the memory 220 and generally controls and coordinates operations of other system components. Similarly, the CPU 202 stores and retrieves application data residing in the memory 220. The CPU 202 is included to be representative of a single CPU, multiple CPU's, a single CPU having multiple processing cores, and the like. The interconnect 206 is used to transmit programming instructions and application data between the CPU 202, I/O device interfaces 208, storage 230, network interfaces 204, and memory 220.

The memory 220 is generally included to be representative of a random access memory and, in operation, stores software applications and data for use by the CPU 202. Although shown as a single unit, the storage 230 may be a combination of fixed and/or removable storage devices, such as fixed disk drives, floppy disk drives, hard disk drives, flash memory storage drives, tape drives, removable memory cards, CD-ROM, DVD-ROM, Blu-Ray, HD-DVD, optical storage, network attached storage (NAS), cloud storage, or a storage area-network (SAN) configured to store non-volatile data.

The memory 220 may store instructions and logic for executing an application platform 226 which may include images 228 and/or photo subject identification software 238. The storage 230 may store images 234 and other user generated media and may include a database 232 configured to store images 234 associated with application platform content 236. The database 232 may also store application content relating to data associated with user generated media or images and other application features for providing the user with an application platform that displays images 234. The database 232 may be any type of storage device.

Network computers are another type of computer system that can be used in conjunction with the disclosures provided herein. Network computers do not usually include a hard disk or other mass storage, and the executable programs are loaded from a network connection into the memory 220 for execution by the CPU 202. A web TV system is also considered to be a computer system, but it may lack some of the features shown in FIG. 2, such as certain input or output devices. A typical computer system will usually include at least a processor, memory, and an interconnect coupling the memory to the processor.

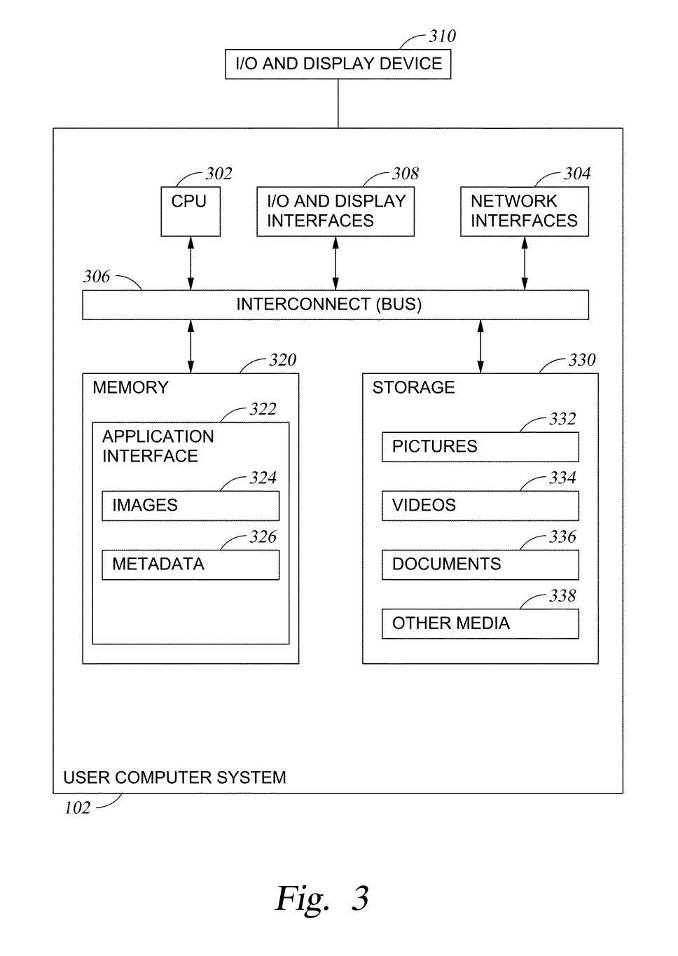

FIG. 3 illustrates a user computer 102 used to access the photo subject display application 112 and display images associated with the application platform 226. The user computer 102 may include, without limitation, a central processing unit (CPU) 302, a network interface 304, an interconnect 306, a memory 320, and storage 330. The user computer 102 may also include an I/O device interface 308 connecting I/O devices 310 (for example, keyboard, display, touchscreen, and mouse devices) to the user computer 102.

Like CPU 202, CPU 302 is included to be representative of a single CPU, multiple CPU's, a single CPU having multiple processing cores, etc., and the memory 320 is generally included to be representative of a random access memory. The interconnect 306 may be used to transmit programming instructions and application data between the CPU 302, I/O device interfaces 308, storage 330, network interface 304, and memory 320. The network interface 304 may be configured to transmit data via the communications network 106, for example, to stream content from the photo subject display application server 112. Storage 330, such as a hard disk drive or solid-state storage drive (SSD), may store non-volatile data. The storage 330 may contain pictures 332, videos 334, documents 336, and other media 338. Illustratively, the memory 320 may include an application interface 322, which itself may display images 324, and/or store metadata 326 of images 324. The application interface 322 may provide one or more software applications which allow the user to access media items and other content hosted by the photo subject display application server 112.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The present example also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, flash memory, magnetic or optical cards, any type of disk including floppy disks, optical disks, CD-ROMs, and magnetic-optical disks, or any type of media suitable for storing electronic instructions, and each coupled to a computer system interconnect.

The algorithms and displays presented herein are not inherently related to any particular computer or other apparatus. Various general purpose systems may be used with programs in accordance with the teachings herein, or it may prove convenient to construct a more specialized apparatus to perform the required method operations. The structure for a variety of these systems will appear from the description above. In addition, the present examples are not described with reference to any particular programming language, and various examples may thus be implemented using a variety of programming languages.

As described in greater detail herein, embodiments of the disclosure provide a software application through which a user may customize an image gallery as displayed on a graphical user interface. The user may customize the image gallery via a selection of a gallery display scheme having one or more display windows. Each display window of the gallery display scheme may comprise one or more first aspect ratios. Furthermore, the software application may apply and display a photo subject area containing a photo subject within the selected display window based upon an analysis of the photo received by the software application. In particular, a gallery display scheme, or layout, containing one or more display windows each maintaining a first aspect ratio is received by the software application. Once the display scheme is received, one or more digital photographs having one or more second aspect ratios is received by the software application. At least one photo subject for each of the one or more digital photos is identified, and subsequently a photo subject area containing the photo subject is identified for each of the one or more digital photos. The photo subject area of each of the one or more digital photos is positioned within the one or more display windows such that each display window displays the photo subject area of one of the one or more digital photos such that the photo subject area is entirely displayed within the display window regardless of the one or more first or second aspect ratios. The display windows are displayed as defined by the gallery display scheme in an image gallery on a graphical user interface.

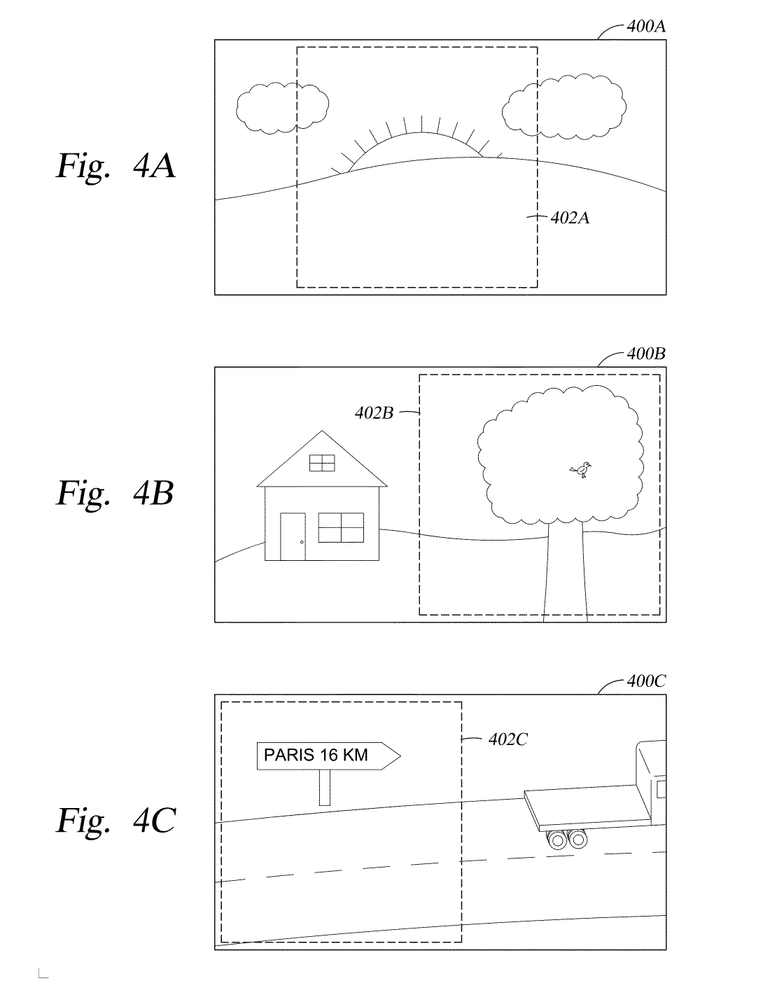

FIGS. 4A, 4B, and 4C, respectively, are conceptual diagrams illustrating applications of a photo subject display to a digital photo 400A, 400B, 400C as uploaded to and received by the photo subject display application according to embodiments described herein.

In the embodiment illustrated in FIG. 4A, the photo subject display application 112 receives a selection of a gallery display scheme. The gallery display scheme may be an order, a format, or a design in which images of a gallery are displayed and presented to a user of the image gallery in display windows. The gallery display scheme display windows may have a first aspect ratio (e.g., a square display window may maintain an aspect ratio of 1:1, a rectangular display window may maintain an aspect ratio of 3:2, etc.). Furthermore, the display windows may have an aspect ratio less than or equal to an aspect ratio of the one or more digital photos. The photo subject display application 112 may further receive one or more digital photos, each digital photo having a second aspect ratio (the aspect ratio in which the photo was captured—e.g., 3:2, 7:5, etc.). For example, a gallery display scheme may present square display windows for displaying images in five rows on a graphical user interface, each row having five display windows. In another example, a gallery display scheme may present triangular and/or circular display windows for displaying images in ten rows on a graphical user interface, each row having six images. Alternatively, by way of another example, a galley display scheme may present display windows with aspect ratios identical to the aspect ratios of the digital photos display within, such that the entire digital photo is displayed within each display window. In the embodiment of FIG. 4A, a square gallery display scheme has been selected by the user and a square display window 402A is shown in phantom over the digital photo 400A. Moreover, digital photo 400A may maintain an aspect ratio different than that of the display window 402A. For example digital photo 400A may maintain an aspect ratio of 3:2, 7:5, etc.

The photo subject display application 112 may analyze the digital photo 400A in order to identify a photo subject of the digital photo 400A. The photo subject may be a primary object of a digital photo. Furthermore, the photo subject may be anywhere within the digital photo (e.g., top right corner, center, bottom left corner, etc.). In identifying the photo subject, the photo subject display application may extract shapes and shadows from within the photo and determine, via a comparison to known shapes, objects, landmarks, etc. stored within the photo subject display application 112, what the shape is. A ranking may be applied to each shape by determining object shapes within the digital photo, such that the shape scoring the highest rank has the most importance within the digital photo and is most likely to be the subject of the photo.

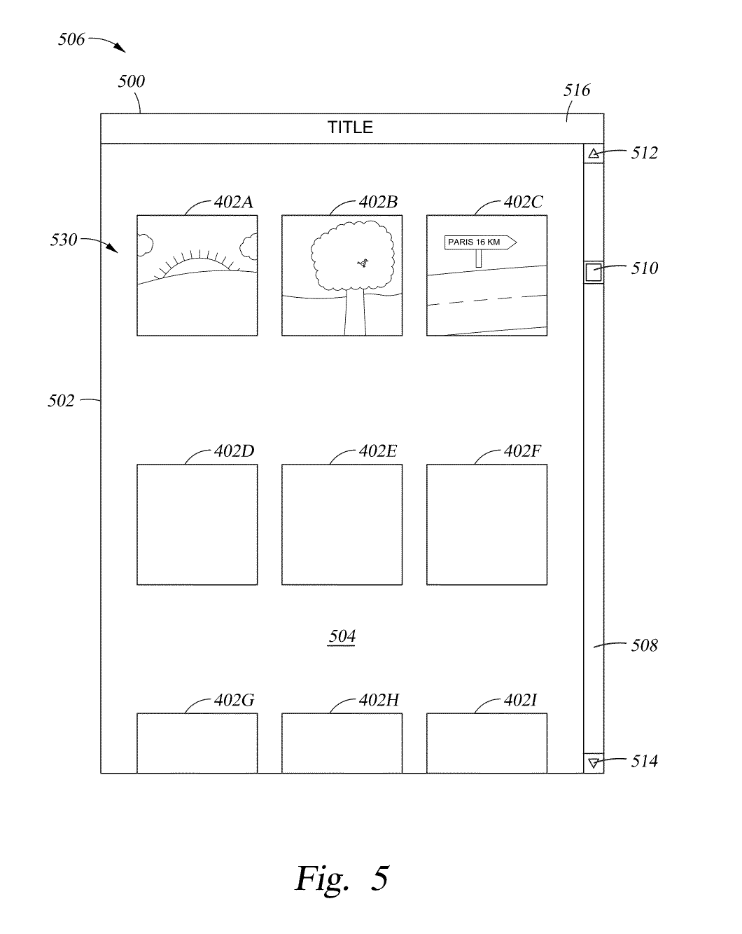

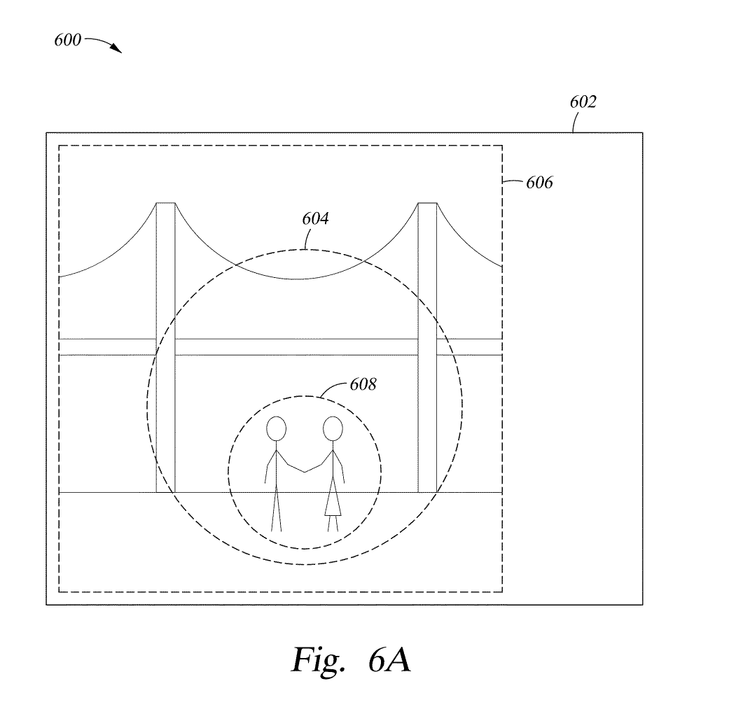

A photo subject area may be identified for each digital photo such that the photo subject area fully encompasses the shape identified as the photo subject of the digital photo. The identification of the photo subject and the photo subject area will be completed for each photo included within the image gallery. In the embodiment illustrated in FIG. 4A, a rising sun over a hill has been identified as the photo subject of the digital photo 400A. Furthermore, the photo subject area may comprise the full sun rise as seen in the digital photo 400A. As such, and based upon the selection of the square gallery display scheme of FIG. 4A, the photo subject display application 112 may display a square display window 402A—having an aspect ratio of 1:1—over the digital photo 400A. The photo subject area is further positioned by the photo subject display application 112 such that the entire photo subject area is within the display window 402A and wherein the photo subject area is displayed within the display window 402A regardless of the first aspect ratio of the display window 402A. Additionally, the photo subject display application 112 may further position the photo subject or the photo subject area toward a center or, alternatively, at the center, of the display window. However, it should be noted that it is not required that the photo subject area be centered within the display window, or even corrected such that the photo subject or photo subject area be repositioned toward the center of the display area. Centering the photo subject or photo subject area may assist, however, in maintaining a visually pleasing image gallery. Briefly turning to FIG. 5, the display window 402A of FIG. 4A is displayed in an image gallery 504 on a graphical user interface 500.

In the embodiment illustrated in FIG. 4B, the photo subject display application 112 receives a selection of a gallery display scheme. In the embodiment of FIG. 4B, as in the embodiment of FIG. 4A, a square gallery display scheme has been selected by the user (see FIG. 5), and, as such, a square display window 402B is shown in phantom over the digital photo 400B. Moreover, digital photo 400B may maintain an aspect ratio different than that of the display window 402B. For example digital photo 400B may maintain an aspect ratio of 3:2, 7:5, etc.

The photo subject display application 112 may analyze the digital photo 400B in order to identify a photo subject of the digital photo 400B. The identification of the photo subject and the photo subject area will be completed for each photo included within the image gallery 504. In the embodiment illustrated in FIG. 4B a bird resting in a tree has been identified as the photo subject of the digital photo 400B. Furthermore, the photo subject area may comprise the area immediately surrounding the bird as seen in the digital photo 400B. As such, and based upon the selection of the square gallery display scheme of FIG. 4B, the photo subject display application 112 may display a square display window 402B having an aspect ratio of 1:1, over the digital photo 400B. The photo subject area is further positioned by the photo subject display application 112 such that the entire photo subject area is within the display window 402B and wherein the photo subject area is displayed within the display window 402B regardless of the first aspect ratio of the display window 402B. Briefly turning to FIG. 5, the display window 402B of FIG. 4B is displayed in an image gallery 504 on a graphical user interface 500.

In the embodiment illustrated in FIG. 4C, the photo subject display application 112 receives a selection of a gallery display scheme. In the embodiment of FIG. 4C, as in the embodiment of FIGS. 4A and 4B, a square gallery display scheme has been selected by the user, and, as such, a square display window 402C is shown in phantom over the digital photo 400C. Moreover, digital photo 400C may maintain an aspect ratio different than that of the display window 402C. For example digital photo 400C may maintain an aspect ratio of 3:2, 7:5, etc.

The photo subject display application 112 may analyze the digital photo 400C in order to identify a photo subject of the digital photo 400C. The identification of the photo subject and the photo subject area will be completed for each photo included within the image gallery 504. In the embodiment illustrated in FIG. 4C, a road sign with text has been identified as the photo subject of the digital photo 400C. Furthermore, the photo subject area may comprise the area immediately surrounding the road sign as seen in the digital photo 400C. As such, and based upon the selection of the square gallery display scheme of FIG. 4C, the photo subject display application 112 may display a square display window 402C having an aspect ratio of 1:1, over the digital photo 400C. The photo subject area is further positioned by the photo subject display application 112 such that the entire photo subject area is within the display window 402C and wherein the photo subject area is displayed within the display window 402C regardless of the first aspect ratio of the display window 402C. Briefly turning to FIG. 5, the display window 402C of FIG. 4C is displayed in an image gallery 504 on a graphical user interface 500.

The graphical user interface 500 illustrated in FIG. 5 is accessible via a web browser application (not illustrated) and may include a plurality of web-based user interface elements, for example, a header, a footer, a body, borders, links, text blocks, and the like, which are arranged to present a digital photo gallery web page within the web browser application. For example, graphical user interface 500 may include a main window 502 that is configured to display the images contained within the image gallery 504. For example, the user interface 500 may be displayed to a user who is viewing a friend's photos via a photo gallery web page, or to a client who is viewing a professional photographer's photo gallery web page.

In the embodiment illustrated in FIG. 5, the user interface 500 displays a photo gallery web page 506 within the main window 502. The user interface 500 of the photo gallery web page 506 may be owned by an administrator user (e.g., a professional photographer) and viewed by a user (e.g., a client of the professional photographer). The main window 502 may contain a window scroll bar 508, a scroll location indicator 510, an up arrow 512, a down arrow 514, and a title bar 516. The photo gallery web page 506 as illustrated in FIG. 5 is configured to display rows of display windows, with each row containing three display windows. As shown, a first row 530 contains display windows 402A, 402B, and 402C. Further display windows 402 are also included.

As described above, a user may select a gallery display scheme. For example, the user can select a gallery display scheme comprising any number of display windows 402 in rows, columns, shapes, sizes, or locations within the main window 502 on the graphical user interface 500. The gallery display scheme may be selected from a pop-up window containing preprogrammed or predetermined gallery display schemes from which the user makes a selection, by typing in a gallery display scheme selection number, or any other suitable gallery display scheme selection techniques. In one embodiment, the selection of a gallery display scheme is made by the administrator user of the photo gallery web page who has identified the gallery display scheme chosen as being aesthetically pleasing based on the images contained within the photo gallery web page.

In one embodiment, after the web server 108 receives a selection of a gallery display scheme (not shown) as well as one or more digital photos (not shown) and before displaying the photo subject area within a display window 402 on the photo gallery web page 506, the photo subject display application 112 identifies and determines the photo subject for each digital photo received in the image gallery 504. Analysis identifying the photo subject of a digital photo performed by the photo subject display application 112 may search the pixels of the digital photo to ascertain the primary object of the digital photo. Every digital photo received by the photo subject display application 112 will have at least one photo subject identified. The photo subject may be a person, a face, an animal, a landmark, an object such as a flower or bicycle, a feature of an object, text, and the like. Furthermore, the photo subject may be a grouping of any of the above, such as a group of people, multiple people in front of a landmark, multiple animals, a field of flowers, an advertisement on a building, a sculpture, the edifice of a building, and the like.

In another embodiment, wherein more than one photo subject is identified within a digital photo, the more than one photo subjects may be included in the photo subject area. For example, if an image includes two birds each sitting on different tree branches of the same tree, both birds may be identified as a primary object of the digital photo. As such, both birds may be included within the photo subject area. Alternatively, only the first bird may be identified as the primary object of the digital photo, and, as such, the first bird may be the only subject included in the photo subject area. A photo subject area may include a single photo subject or multiple subjects as the primary object of the digital photo.

In identifying the photo subject the photo subject display application 112 may extract shapes, images, colors, shadows, patterns, etc. from the pixels within the photo. Analysis is performed on the extracted shapes, images, colors, shadows, patterns, etc. in order to identify the shape, image, color, shadow, pattern, etc. A comparison may be employed in order to evaluate the identification made against known shapes, images, colors, shadows, patterns, etc. stored within the photo subject display application 112. A ranking may be applied to each extracted shape, image, color, shadow, pattern, etc. such that the extracted item scoring the highest rank has the most importance within the digital photo and is determined to be the most likely photo subject of the photo. For example, a digital photo may comprise a person posing in front of a landmark. The person and the landmark may all be identified as the photo subject. However, in one embodiment the person may score a higher rank than the landmark. As such, the person may be identified as the highest scoring photo subject and, subsequently, be identified as the photo subject. Alternatively, in another embodiment, the person and the landmark may score the same rank. As such, the person and the landmark may be identified as the photo subject. Alternatively, in another embodiment, a digital photo may comprise an image of the same color, e.g., a solid blue sky. Each pixel within the digital photo may rank the same, and as such the entire photo may be the photo subject area, or, alternatively, only a portion of the photo may comprise the photo subject area as the entire photo ranked equally.

A photo subject area may subsequently be identified for each digital photo such that the photo subject area fully encompasses the identified photo subject of the digital photo, as identified above. The photo subject display application 112 may select a cohesive region (not shown) encompassing all identified photo subjects. The cohesive region may not be visible to a user. Furthermore, the cohesive region may be of any shape, such as a square or rectangle. The cohesive region comprising the photo subject may be the photo subject area. The identification of the photo subject and the photo subject area will be completed for each photo included within the image gallery.

As illustrated in FIG. 5 an administrator user, such as a professional photographer, has selected a gallery display scheme for an image gallery 504 comprising nine display windows 402A-402I, displayed in three rows with each row containing three display windows 402. Each display window selected has been configured to have an aspect ratio of 1:1, and as such the display windows 402A-402I are represented by a square shape within the main window 502 of the image gallery 504. Despite the aspect ratio of the photos received by the photo subject display application 112, the identified photo subject area and the identified photo subject(s) will be displayed within the display windows 402A-402I, with each display window 402A-402I displaying the photo subject area of one digital photo.

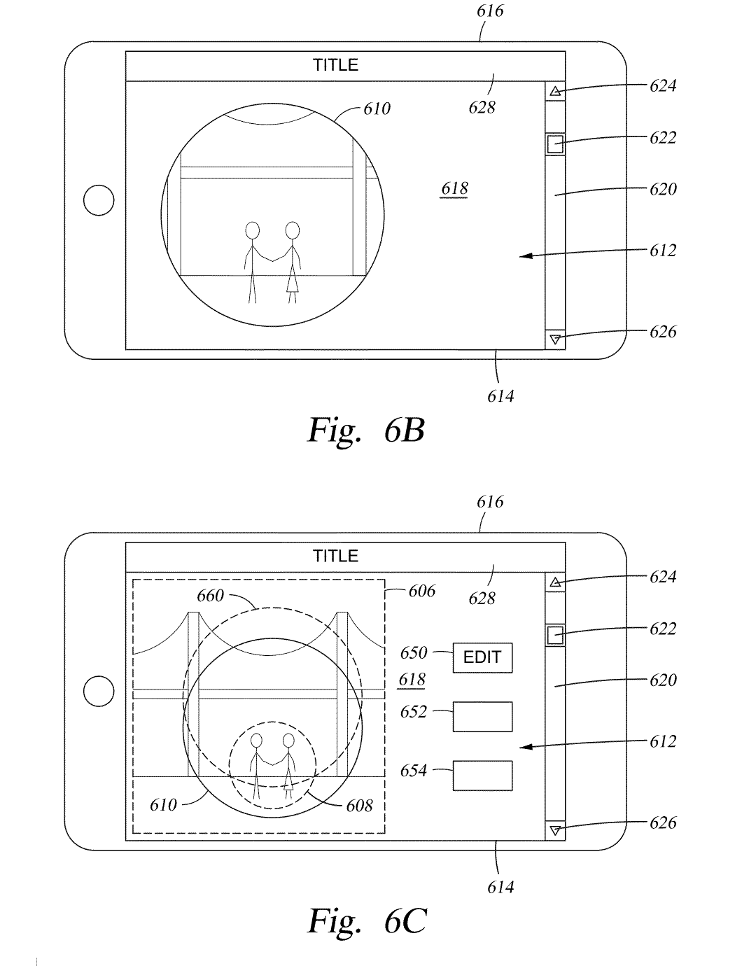

FIG. 6A illustrates another embodiment of the photo subject display application 112 as shown on a graphical user interface 600. In FIG. 6A a selection of a gallery display scheme has been received by the photo subject display application. In this embodiment, a circular gallery display scheme has been received and is displayed within a main window 602 of the graphical user interface 600. As such, a circular display window 604 has been created and displayed (in phantom) over a digital photo 606 received by the photo subject display application 112 for display in an image gallery 612 (See FIG. 6B). The photo subject display application 112 has identified the photo subject of the digital photo 606 as being two people. As such, a photo subject area 608 has been created (in phantom) by the photo subject display application 112 to surround the photo subject (the two people) of the digital photo 606, however the photo subject area 608 is not visible to a user as it is internal to the photo subject display application 112.

Turning to FIG. 6B, the photo subject area 608 may be positioned within the circular display window 604 and the circular display window 604 may be positioned within a display window 610 within a main window 618 of an image gallery 612 on a photo gallery web page 614 as displayed to a user on a graphical user interface 616. As stated above, the photo gallery web page 614 may include a main window 618 containing a window scroll bar 620, a scroll location indicator 622, an up arrow 624, a down arrow 626, and a title bar 628. The photo gallery web page 614, as illustrated in FIG. 6B, is configured to display a column of display windows, with each column containing one display window.

In the event that an administrator user of the photo gallery web page 614 (e.g., a professional photographer) is unsatisfied with photo subject area selected by the photo subject display application 112, or in the event that the photo subject display application 112 has selected the incorrect photo subject area, or if a different photo subject area is preferred, the photo subject display application 112 allows for a manual selection of a photo subject area to be displayed through a display window within the a main window of an image gallery.

FIG. 6C illustrates the embodiment of FIG. 6B wherein an administrator user desires to correct the photo subject area 608 of the digital photo 606. As illustrated in FIG. 6C, the digital photo 606 as uploaded to the photo subject display application 112 is shown in phantom, however a circular display window 610 containing the photo subject area 608 as previously identified by the photo subject display application 112 is shown positioned within a main window 618 of an image gallery 612 on a photo gallery web page 614 as displayed to a user on a graphical user interface 616. However, in the embodiment of FIG. 6C, the administrator user desires to change the portion of the digital photo 606 displayed within the circular display window 610. Rather than displaying the photo subject area 608 as identified by the photo subject display application 112, the administrator user may override the photo subject display application's 112 identification through the use of photo editing tools 650, 652, 654, or options, e.g., an edit button, provided by the photo subject display application 112 and displayed within the photo gallery web page 614 for manually editing the display windows. Upon activation of a photo editing tool or an option by an administrator user the administrator user may manually move, for example via the use of a click and drag operation of a mouse, display window from a first location to a second location. As illustrated in FIG. 6C, the administrator user has selected a second display window 660 as the desired display window to be positioned around a photo subject of the digital photo 606. As such, the second display window 660 is displayed within the main window 618 of the image gallery 612 on a photo gallery web page 614 as displayed to a user on a graphical user interface 616.

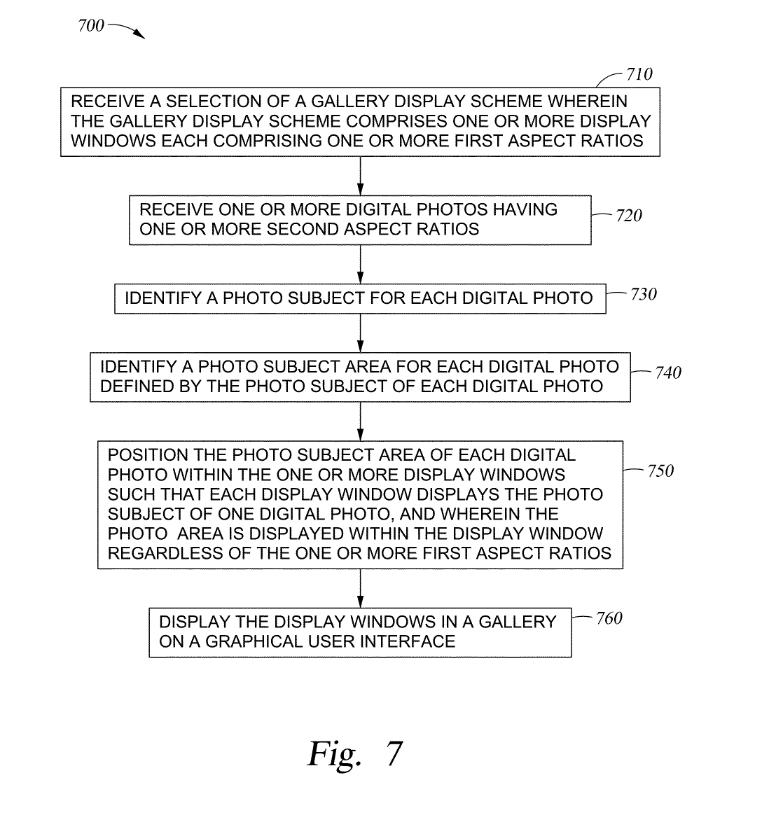

FIG. 7 schematically illustrates operations of a method 700 for photo subject display of a photo subject as displayed in an image gallery according to one embodiment described herein. The method 700 generally relates to embodiments wherein digital photos comprising photo subjects are displayed within a display window on a photo gallery web page and viewed by a user on a graphical user interface. Based on an identification of a photo subject and a photo subject area performed as soon as a photo is received by the photo subject display application 112, the photo subject display application 112 may ensure that the primary subject of a digital photo is displayed within a display window of an image gallery without regard to the aspect ratio of the photo or the display window. At operation 710, a selection of a gallery display scheme is received wherein the gallery display scheme comprises one or more display windows, each display window comprising one or more first aspect ratios. The gallery display scheme is made by an administrator user, generally the owner of the photo gallery web page (e.g., a photographer). At operation 720, one or more digital photos having one or more second aspect ratios are received. The one or more digital photos may be uploaded by the administrator user to a photo gallery web page which contains the photo subject display application 112.

At operation 730, a photo subject for each digital photo is identified. At operation 740 a photo subject area for each digital photo is identified as defined by the photo subject of each digital photo. At operation 750 the photo subject area of each digital photo is positioned within the one or more display windows such that each display window displays the photo subject of one digital photo, and wherein the photo subject area is displayed within the display window regardless of the one or more first aspect ratios. Each display window may display the photo subject area of one digital photo. At operation 760 the display windows are displayed in a gallery on a graphical user interface.

The photo subject display application creates an enhanced display of an online image gallery in order to improve the viewing experience of a user on a graphical user interface. Each image displayed may benefit individually or as a gallery from a tailored display scheme of the image(s), such that the image gallery remains aesthetically pleasing and consistently displays the photo subject of each digital photo, as images are displayed within the main window of the online image gallery.

While the foregoing is directed to embodiments described herein, other and further embodiments may be devised without departing from the basic scope thereof. For example, aspects of the present disclosure may be implemented in hardware or software or in a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (for example, read-only memory devices within a computer such as CD-ROM disks readable by a CD-ROM drive, flash memory, ROM chips or any type of solid-state non-volatile semiconductor memory) on which information is permanently stored; and (ii) writable storage media (for example, floppy disks within a diskette drive or hard-disk drive or any type of solid-state random-access semiconductor memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto that are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is claimed is:

1. A method for analyzing and applying a photo subject display to an image, the method comprising:
receiving a selection of a gallery display scheme wherein the gallery display scheme comprises one or more display windows each comprising one or more first aspect ratios;
receiving one or more digital photos having one or more second aspect ratios;
identifying a photo subject for each of the one or more digital photos;
identifying a photo subject area for each of the one or more digital photos defined by the photo subject of each of the one or more digital photos;
positioning the photo subject area of each of the one or more digital photos within the one or more display windows such that each display window displays the photo subject area of one of the one or more digital photos, and wherein the photo subject area is displayed within the display window regardless of the one or more first aspect ratios; and
displaying the display windows in a gallery on a graphical user interface.

2. The method of claim 1, wherein the photo subject area is positioned toward a center of the display window.

3. The method of claim 2, wherein the photo subject area is centered within the display window.

4. The method of claim 1, wherein the first aspect ratio of the display window is less than or equal to the second aspect ratio of the digital photos.

5. The method of claim 1, wherein the display window fully contains the photo subject area.

6. The method of claim 1, wherein the photo subject is determined by extracting shapes within the one or more digital photos.

7. The method of claim 1, wherein digital photo editing tools are provided for manual editing of the one or more display windows.

8. A computer system for analyzing and applying a photo subject display to an image, comprising:
a processor; and
a memory storing instructions that, when executed by the processor, cause the computer system to:
receive a selection of a gallery display scheme wherein the gallery display scheme comprises one or more display windows each comprising one or more first aspect ratios;
receive one or more digital photos having one or more second aspect ratios;
identify a photo subject for each of the one or more digital photos;
identify a photo subject area for each of the one or more digital photos defined by the photo subject of each of the one or more digital photos;
position the photo subject area of each of the one or more digital photos within the one or more display windows such that each display window displays the photo subject area of one of the one or more digital photos, and wherein the photo subject area is displayed within the display window regardless of the one or more first aspect ratios; and
display the display windows in a gallery on a graphical user interface.

9. The computer system of claim 8, wherein the photo subject area is positioned toward a center of the display window.

10. The computer system of claim 9, wherein the photo subject area is centered within the display window.

11. The computer system of claim 8, wherein the first aspect ratio of the display window is less than or equal to the second aspect ratio of the digital photos.

12. The computer system of claim 8, wherein the display window fully contains the photo subject area.

13. The computer system of claim 8, wherein the photo subject is determined by extracting shapes within the one or more digital photos.

14. The computer system of claim 8, wherein digital photo editing tools are provided for manual editing of the one or more display windows.

15. A non-transitory computer-readable medium storing instructions that, when executed by a processor, cause a computer system to analyze and apply a photo subject display to an image, by performing the steps of:
receiving a selection of a gallery display scheme wherein the gallery display scheme comprises one or more display windows each comprising one or more first aspect ratios;
receiving one or more digital photos having one or more second aspect ratios;
identifying a photo subject for each of the one or more digital photos;
identifying a photo subject area for each of the one or more digital photos defined by the photo subject of each of the one or more digital photos;
positioning the photo subject area of each of the one or more digital photos within the one or more display windows such that each display window displays the photo subject area of one of the one or more digital photos, and wherein the photo subject area is displayed within the display window regardless of the one or more first aspect ratios; and
displaying the display windows in a gallery on a graphical user interface.

16. The non-transitory computer-readable medium of claim 15, wherein the photo subject area is positioned toward a center of the display window.

17. The non-transitory computer-readable medium of claim 16, wherein the photo subject area is centered within the display window.

18. The non-transitory computer-readable medium of claim 15, wherein the first aspect ratio of the display window is less than or equal to the second aspect ratio of the digital photos.

19. The non-transitory computer-readable medium of claim 15, wherein the display window fully contains the photo subject area.

20. The non-transitory computer-readable medium of claim 15, wherein the photo subject is determined by extracting shapes within the one or more digital photos.

21. The non-transitory computer-readable medium of claim 15, wherein digital photo editing tools are provided for manual editing of the one or more display windows.
